(19) United States
(12) Patent Application Publication
(10) Pub. No.: US 2005/0288944 A1
(43) Pub. Date: Dec. 29, 2005

(54) Program for matching people's personalities

(75) Inventors: Kevin Leman, Ashville, NY (US); David Bolthouse, Oro Valley, AZ (US); John Patton, Oro Valley, AZ (US)

Correspondence Address: Mark E. Ogram, Ste 203, 7454 E. Broadway, Tucson, AZ, 85710, US

(73) Assignee: SurfVantage LLC (Arizona), Tucson, AZ (US)

(21) Appl. No.: 10/877,815

(22) Filed: Jun. 24, 2004

(51) Int. Cl. G06F 17/60

(52) U.S. Cl. 705/1

(57) ABSTRACT

An Internet matchmaking system in which the match-making computer presents a series of questions to a first individual; the answers are received together with an associated weighting factor. These answers/values generate an index which are used to identify a second individual from a data-base. Questions, originating from the data-base individual, are communicated to the first individual who responds with answers. These answers are used by the data-base individual to determine if contact with the first individual is sought.

### BACKGROUND OF THE INVENTION

This invention relates generally to the Internet and more specifically to the use of the Internet allowing individuals to meet other individuals with similar interests.

To say that the Internet has transformed society would be an understatement. Individuals are now able to develop conversations with an almost limitless universe of people. This is seen by the proliferation of “chat rooms” and the use of e-mail. No longer are we limited to interacting with people that we physically meet; the Internet allows people to “talk” with people that would never enter the physical realm of the individual.

This has opened the eyes of the Internet user that a romantic interest is possible with individuals that are a great distance from each other. The very power of the Internet, permitting an expansive universe of potential suitors, is also the source of a great deal of problems. How is an individual able to sort through this vast universe to find “that one” individual. The problem is so daunting that a great many give up without really trying.

In an effort to simplify the problem, a large number of “match-making” or “dating” services have been developed. Typically, the user of such services identifies themself through certain preset parameters (e.g. Age, height, weight, race, religion, etc.) and what they are seeking (male/female; age range, height range, weight range, race, religion, etc.). This latter group is used to sort through a data-base of individuals who fall into these parameters.

The person using the services are then given a listing of the people who have the characteristics sought.

Unfortunately, these types of “screens” have focused on characteristics that are superficial and do not really reflect the individual. While height, weight, and race, form a threshold for attraction, it is the personality and intellect that will make the match successful or not. These characteristics though are very unique to the individual and are difficult or impossible to ascertain through questions. Because of this, the vast majority of these “matches” are unsuccessful.

It is clear there is a need for an enhanced ability to match individuals with a greater chance of providing a successful “match”.

### SUMMARY OF THE INVENTION

The present invention provides a method and an Internet system for matching individuals with like interests.

While the discussion below relates to the Internet, those of ordinary skill in the art readily recognize that the invention is applicable to any network of computers or for use on a stand-alone computer.

Within this context, there are at least two individuals. The “searching-individual” refers to the individual who has entered the computer and who is attempting to find a “match”; the “data-base-individual” is the person who has their own specific information stored upon the data-base within the computer.

In operation, once the searching-individual enters the program within the computer, a series of questions are presented. The searching-individual responds to the questions and also provides for a weighting factor for the question; thereby, identifying the importance of each answer. In this context, a portion of the searching-individual's response is objective relative to the individual that the searching-individual would like to meet (e.g. age, height, etc.) and a portion of the response is subjective (e.g. How important is age?).

The answer is combined with the appropriate individual's weighting factor to produce an index. Those of ordinary skill in the art readily recognize that there are a variety of techniques which are applicable to the creation of this index. One such approach is the creation of an array or vector in which the weights and response are stored.

The index is used to identify individuals within the database that are the best “match”. This procedure is accomplished through a variety of techniques well known to those of ordinary skill in the art. One such approach is to utilize the array in matching with the stored values within the data base, creating a “raw score”.

For purposes of illustration only, let's assume the following questions are given for the indicated weights:

| Question | Answer | Weight (1-5) |
|---|---|---|
| 1) Religion of individual sought | Baptist | 5 (Highest) |
| 2) Location of individual sought | California | 3 |
| 3) Education of individual sought | High School | 1 (Lowest) |
| 4) Can the individual have children | Yes | 1 |
| 5) Can the individual want children | Yes | 5 |

The resulting arrays by the searching-individual would then be:
Answer Array: (Baptist, California, High School, Yes, Yes)
Weight Array: (5, 3, 1, 1, 5)

In comparing this searching-individual with one within the data-base having the following arrays:
Answer Array: (Baptist, New York, High School, No, Yes)
Weight Array: (5, 2, 4, 5, 5)

The matches count for one point, the misses, zero. The result is then multiplied by the weights given and a sum is created generating a raw score of:
Cross Match Array: (1, 0, 1, 0, 1)
Searching-Individual Weight (5, 3, 1, 1, 5)
Data-Base-Individual Weight (5, 2, 4, 5, 5)

Multiplying each column and then taking the sum, the result is: 25+0+4+0+25=54 for the raw score for the compatibility of the two. For each of the data-base-individuals, the raw score is calculated and the highest value(s) are withdrawn for the searching-individual's consideration.

In one embodiment, to further identify compatibility, a set of questions created by the matched data base individual are present to the inquiring individual. This permits the data-base-individual to obtain important information about the inquiring-individual. As example, the data-base-individual may ask questions like:
“Are you a cat or a dog person?”
“What was the last movie you saw that you liked?”
“Have you been divorced?”
“Are you involved with politics?”
Where did you last go on vacation?”

Armed with the answers from the inquiring-individual, the data-base-individual is able to determine if they want to proceed with the meeting as the questions allow the data-base-individual to gain an insight into the inquiring-individual that would otherwise be omitted simply by the pre-arranged questions of the survey.

These answers are communicated to the data-base-individual prior to any contact being allowed between the inquiring-individual and the data-base-individual.

In yet another embodiment of the invention, specific questions in the area of religion or the person's birth order are presented. Prior to the search of the data-base, the data-base had been broken into sub-sets whereby a particular sub-set is appropriate for individual answers to either the religion or birth-order responses. In this way, the search of the data base is expedited since only the sub-set needs to be searched.

The invention, together with various embodiments thereof, will be more fully explained by the accompanying drawings and the following description thereof.

### DRAWINGS IN BRIEF

FIG. 1 is a block diagram of the environment for this invention, the Internet.

FIG. 2 is a flow-chart of how data is entered into the data-base.

FIG. 3 is a flow-chart of how a search is conducted on the data-base.

FIG. 4 is a flow-chart of how the computer handles the making/not-making a connection between the two individuals.

FIG. 5, is a flow-chart of how an individual is able to suspend their information from the data-base.

### DRAWINGS IN DETAIL

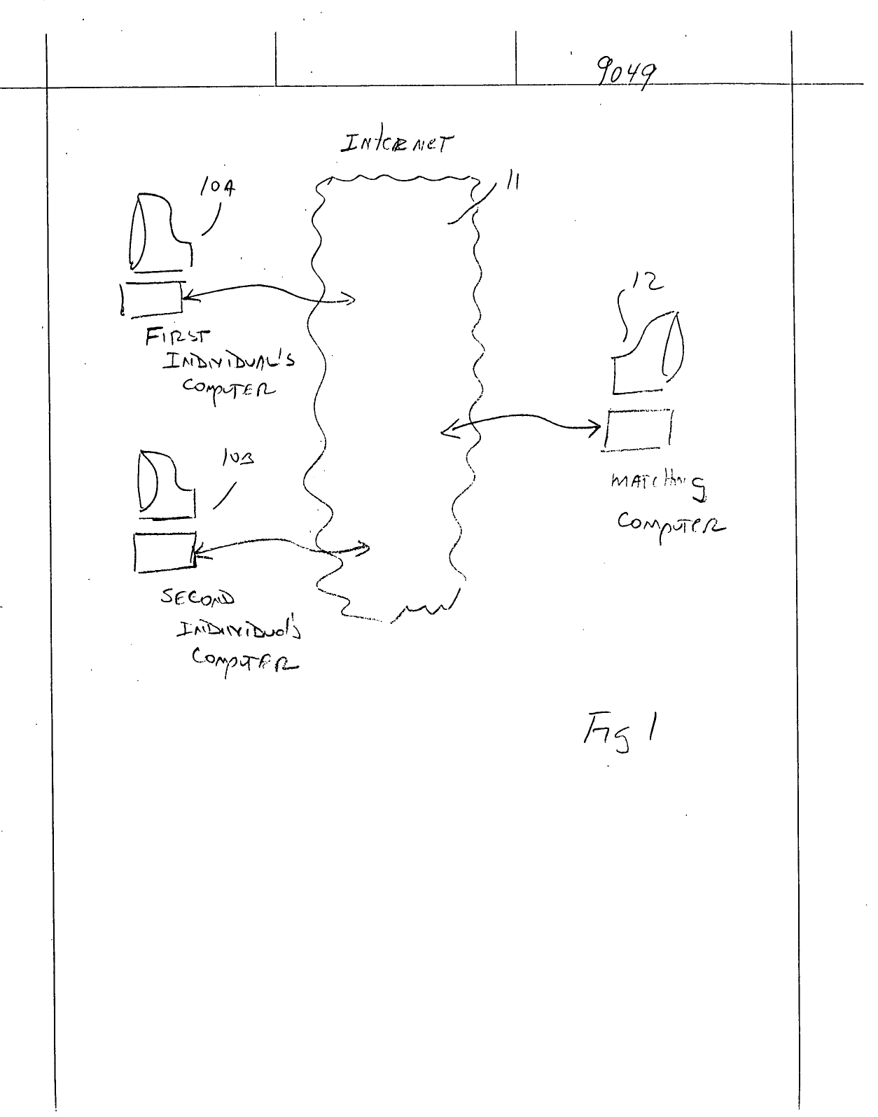

FIG. 1 is a block diagram of the environment for this invention, the Internet.

The Internet 11 permits remotely located computers to access each other. In this case, the matching computer 12 is accessible by any number of computers including the first individual's computer 10A and the second individual's computer 10B. For this discussion, the first computer 10A is the “searching-individual” while the second computer 10A represents the “data-base-individual”.

In like fashion, according to the invention, eventually the first computer 10A and the second computer 10B are put into direct communication with each other.

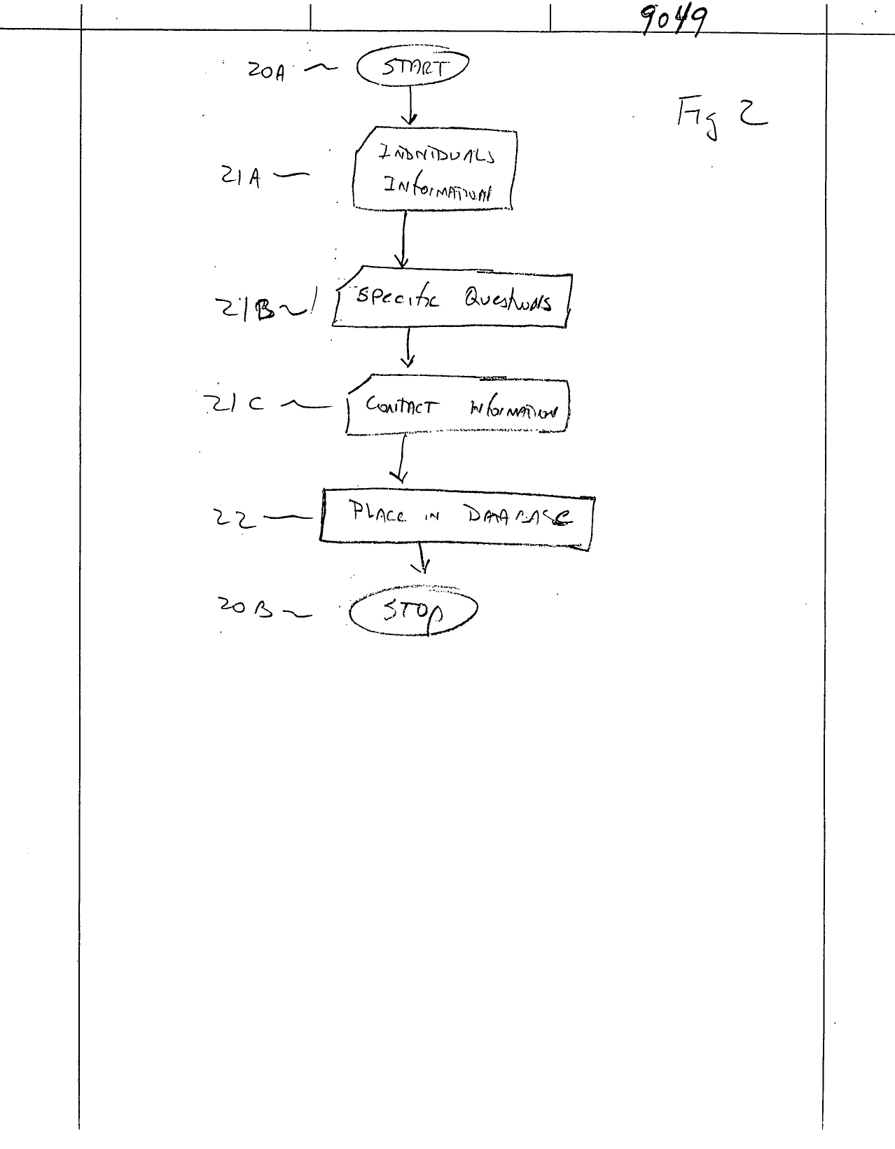

FIG. 2 is a flow-chart of how data is entered into the data-base. This operation is made by the second computer 10B (as well as many others) for the creation of the data-base.

Once second computer 10B has contacted the matching computer 12, the program outlined in this figure is initiated. The program starts 20A and collects the individual's information 21A. This is information which has been pre-arranged (e.g. gender, age, weight, race, etc.).

Following this, questions specific to the individual are collected 21B. These would be questions that the individual would want answered by someone who “matches” their profile. As discussed earlier, this might be something like, “Are you a cat or dog person?”.

Thereafter, the contact information for the individual would be obtained 21 C. This allows contact to be made through such techniques as e-mail, Instant Messaging (“IM”), or even phone numbers.

The collected information is properly formatted and stored in the data base 22 and the program stops 20B.

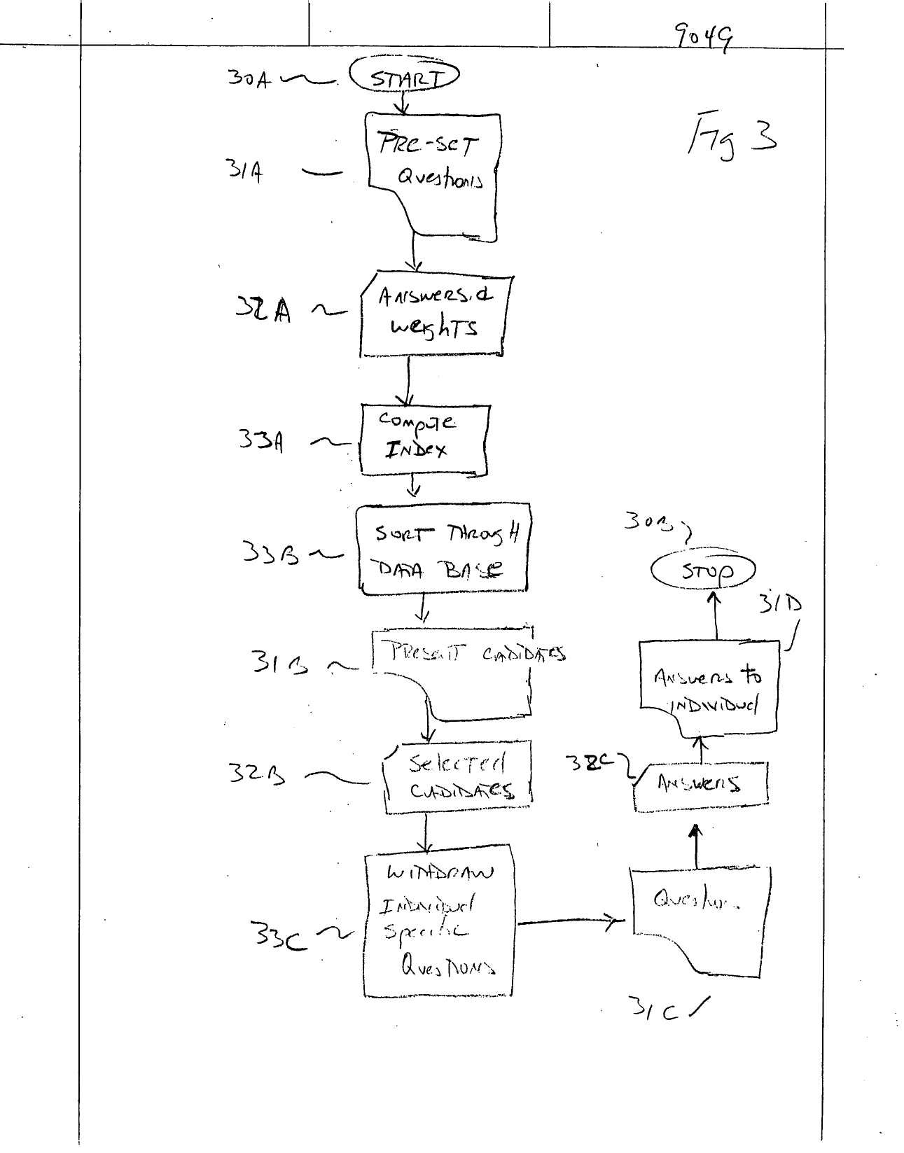

FIG. 3 is a flow-chart of how a search is conducted on the data-base. In this case, the first individual's computer 10A has contacted the matching computer 12 in an effort to find a “matching” individual.

Once the program starts 30A, a series of preset questions 31A are given to the searching-individual. These questions attempt to put parameters on the individual being sought (e.g. age range, religion, weight range, etc.). The searching-individual responds with the answers and associated weights 32A. As outlined above, the weighting is a subjective value on the “importance” each answer contains to the searching-individual.

In some embodiments of the invention, these questions include questions on the birth-order of the searching-individual; permitting the program to choose a subset of the data base having only those individuals with compatible birth-orders.

In yet another embodiment, the questions include a question on religion which has been shown to have more affect on the compatibility of two people than previously thought. Again, in this embodiment, only compatible religions are in the subset which is searched.

Using the answers and weights, an index value is computed 33A and the data-base is sorted 33B to find the closest matches. In some embodiments of the invention, only a single “best match” is found, but, in the preferred embodiment the top ten matches are then presented 31B to the searching-individual. This presentation involves the basic parameters that the individuals had provided on themselves.

The searching-individual then selects which of the ten candidates interest him 32B. The program then withdraws the personal questions associated with each of the chosen candidates 32B and presents these questions to the searching individual 31C.

The answers 32C for the personal questions are collected and sent to the individual within the data base 31D. The program then stops 30B.

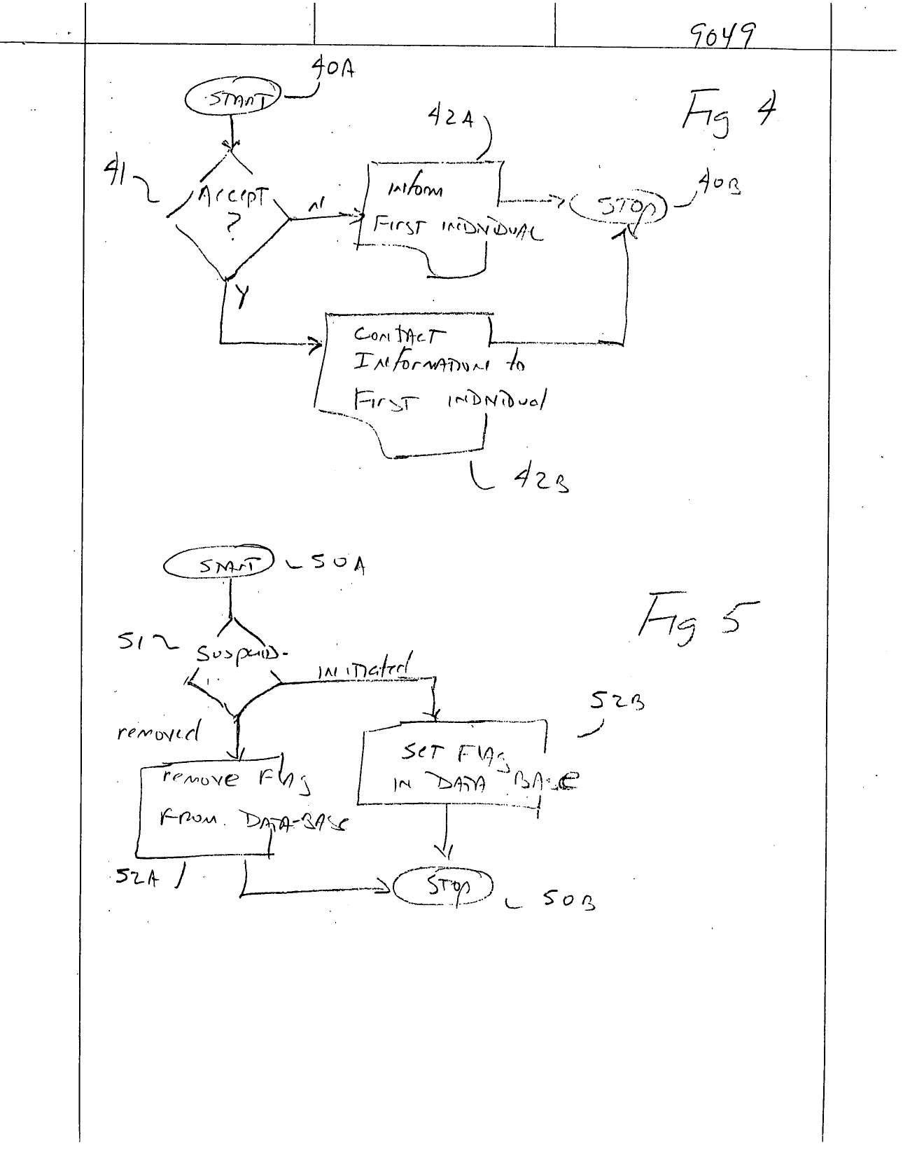

FIG. 4 is a flow-chart of how the computer handles the making/not-making a connection between the two individuals.

The data-base-individual, after having received the searching-individual's answers to the personal questions as outlined in FIG. 3, starts this program 40A and indicates if there is a desire to make contact or not with the searching-individual 41. If there is no acceptance, then the searching-individual so informed 42A and the program stops 40B.

If there is an acceptance, 41A, then the contact information on the data-base-individual is communicated to the searching-individual 42B and the program stops 40B.

FIG. 5, is a flow-chart of how an individual is able to suspend their information from the data-base.

One aspect of the present invention is its ability to “suspend” a data file on an individual from the data-base. In this manner, the data-base-individual is able to remove themselves temporarily from consideration without totally removing themselves from the data-base.

The data-base-individual starts the program 50A and states on whether they want to “suspend” or not 51. If suspension is sought, then the appropriate file within the data base is “flagged” 52B and the program stops 50B. Removal of suspension is when the “flag” is removed 52B; and, the program stops 50B.

It is clear that the present invention provides for a highly improved method and system for successfully matching individuals.

1. A method of matching individuals comprising the steps of:
a) presenting a series of questions to a first individual;
b) accepting a series of answers and associated weighting factors from said first individual in response to said series of questions;
c) generating a first individual's index based upon said series of answers and said weighting factor for each answer; and,
d) from a data base, identifying a second individual having an associated index approximating the first individual's index value.

2. The method of matching individuals according to claim 1, further including the steps of:
a) copying from a persona query data base, a series of individual specific questions generated by said second individual;
b) presenting said individual specific questions to said first individual;
c) accepting a set of answers to said individual specific questions from said first individual; and,
d) communicating said set of answers to the second individual.

3. The method of matching individuals according to claim 2, further including the steps of:
a) receiving an authorization from said second individual; and,
b) based upon said authorization, permitting said first individual and said second individual to communicate with each other.

4. The method of matching individuals according to claim 3, wherein a birth order question is included in said series of questions.

5. The method of matching individuals according to claim 4,
a) wherein a subset of said data base is created based upon an answer associated with said birth order question; and,
b) wherein only said subset is used as the data base in the step of identifying a second individual having an index value approximating the first individual's index value.

6. The method of matching individuals according to claim 3, wherein a religion association question is included in said series of questions.

7. The method of matching individuals according to claim 6,
a) wherein a subset of said data base is created based upon an answer associated with said religion association questions.; and,
b) wherein only said subset is used as the data base in the step of identifying a second individual having an index value closest to the first individual's index value.

8. The method of matching individuals according to claim 3, further including the step of suspending from consideration data associated with said individual from said data base in response to instructions from said individual.

9. A computer adapted to match individuals comprising:
a) means for presenting a series of questions to a first individual;
b) means for accepting a series of answers and associated weighting factors from said first individual in response to said series of questions;
c) means for generating a first individual's index based upon said series of answers and said weighting factor for each answer; and,
d) from a data base within said computer, means for identifying a second individual having an associated index approximating the first individual's index value.

10. The computer according to claim 9, further including:
a) means for copying from a personal query data base, a series of individual specific questions generated by said second individual;
b) means for presenting said individual specific questions to said first individual;
c) means for accepting a set of answers to said individual specific questions from said first individual; and,
d) means for communicating said set of answers to the second individual.

11. The computer according to claim 10, further including:
a) means for receiving an authorization from said second individual; and,
b) based upon said authorization, means for permitting said first individual and said second individual to communicate with each other.

12. The computer according to claim 11, further including:
a) means for directing a birth order question within said series of questions;
b) means for establishing a subset of said data base based upon an answer associated with said birth order question; and,
c) means for identifying a second individual having an index value approximating the first individual's index value using said subset.

13. The computer system according to claim 12, further including:
a) means for including a religion association question in said series of questions;
b) means for establishing a subset of said data base based upon an answer associated with said religion association question; and,
c) means for using only said subset for identifying a second individual having an index value closest to the first individual's index value.

14. An Internet system comprising:
a) a network permitting remotely located computers to communicate with each other;
b) a user computer connected to said network; and,
c) a matching computer connected to said network of computers, said matching computer having,
1) means for presenting a series of questions to a first individual at said user computer,
2) means for accepting a series of answers and associated weighting factors from said first individual in response to said series of questions,
3) means for generating a First individual's index based upon said series of answers and said weighting factor for each answer,
4) means for identifying a second individual having an associated index approximating the first individual's index value, and,
5) means for communicating information on the second individual to said first individual via said network.

15. The Internet system according to claim 14, wherein said matching computer further includes:
a) means for presenting individual specific questions established by said second individual to said first individual;.
b) means for accepting a set of answers to said individual specific questions from said first individual; and,
c) means for communicating said set of answers to the second individual via said network.

16. The Internet system according to claim 15, wherein said matching computer further includes:
a) means for receiving an authorization from said second individual via said network; and,
b) based upon said authorization, means for permitting said first individual and said second individual to communicate with each other via said network.

17. The Internet system according to claim 16, wherein said matching computer further includes:
a) means for directing a birth order question within said series of questions;
b) means for establishing a subset of said data base based upon an answer associated with said birth order question; and,
c) means for identifying a second individual having an index value approximating the first individual's index value using said subset.
